(19) United States
(12) Patent Application Publication
(10) Pub. No.: US 2005/0002170 A1
(43) Pub. Date: Jan. 6, 2005

(54) Electronic device remote control keypad back lighting light pipe

(76) Inventors: Neal Kenneth Jacobs, Carmel, IN (US); Gregg Michael Morgan, Carmel, IN (US)

Correspondence Address: THOMSON MULTIMEDIA LICENSING INC;JOSEPH S TRIPOLI, PO BOX 5312, 2 INDEPENDENCE WAY, PRINCETON, NJ, 08543-5312, US

(21) Appl. No.: 10/611,692

(22) Filed: Jul. 1, 2003

(51) Int. Cl. G01D 11/28

(52) U.S. Cl. 362/23

(57) ABSTRACT

An electronic device remote control having a back lit keypad, wherein the electronic device remote control includes a housing, a circuit board, a keypad, and a light pipe. The circuit board has at least one surface mounted light emitting diode (LED). The keypad has a base positioned directly adjacent to a top surface of the circuit board. The base has a plurality of buttons extending away from the circuit board and at least one slot corresponding to the at least one surface mounted LED. The light pipe has openings corresponding to the buttons of the keypad. The light pipe is positioned on the keypad such that the buttons extend through the openings therein so that light is dispersed through the light pipe to the buttons. The housing includes a top cover having a plurality of apertures corresponding to the buttons. Dividers extend from an inside surface of the top cover to contact the light pipe and the base of the keypad. The dividers are arranged to receive the buttons therebetween.

### FIELD OF THE INVENTION

The invention relates to an illumination device for illuminating a keypad of an electronic device remote control. More specifically, the invention relates to a light pipe for back lighting a keypad of an electronic device remote control.

### BACKGROUND OF THE INVENTION

Electronic device remote controls that have a keypad illuminated by back lighting typically consist of a light pipe, a circuit board, and a keypad contained in a two-cover housing. The keypad is positioned adjacent to a top surface of the circuit board and has buttons that project through apertures in a top cover of the housing. A contact is provided on a base of each of the buttons adjacent to conductive contacts arranged on the top surface of the circuit board. To light the keypad, a plurality of Light Emitting Diodes (LEDs) is arranged on a top surface of the circuit board. A light pipe that disperses the light emitted from the diodes is arranged between the circuit board and the keypad. The light pipe has a plurality of openings corresponding to the contacts on each of the buttons so that when the buttons are pressed toward the circuit board, the contacts provided on the base of the buttons extend through the openings and contact conductive contacts on the circuit board to make an electrical connection.

Because the light pipe is positioned between the circuit board and the keypad, the thickness of the light pipe must be accounted for early in the design stage to ensure that the height of the remote control is large enough to compensate for the thickness of the light pipe. Since the addition of the light pipe increases the height of the remote control, the light pipe can not be used to convert existing remote controls to remote controls with back lighting. In addition, different tooling must be used to produce a remote control with and without back lighting. The positioning of the light pipe between the circuit board and the keypad also requires the light pipe to be relatively flat and substantially the same size as the keypad thereby dictating the size and shape of the remote control. Because the light pipe must be relatively flat and substantially the same size as the keypad, the amount of room available to catch and distribute the light to the keypad is limited and the ability to modulate the distribution of the light is restricted.

### SUMMARY OF THE INVENTION

The invention relates to an electronic device remote control having a back lit keypad. The electronic device remote control includes a housing, a circuit board, a keypad, and a light pipe. The housing including a top cover having a plurality of apertures and a bottom cover. The circuit board has a light emitting diode. The keypad has a base with a plurality of buttons extending through the apertures of the top cover. The light pipe is positioned on a top surface of the keypad between the top cover of the housing and the keypad so that light is dispersed through the light pipe to the buttons.

### BRIEF DESCRIPTION OF THE DRAWINGS

FIG. 1 is an exploded view of an electronic device remote control according to the invention.

FIG. 2 is a front perspective view of the electronic device remote control with a top cover removed.

FIG. 3 is a perspective view of a bottom surface of the light pipe.

FIG. 4 is a cross-sectional view of the electronic device remote control taken along line 4-4 of FIG. 2.

### DETAILED DESCRIPTION OF THE INVENTION

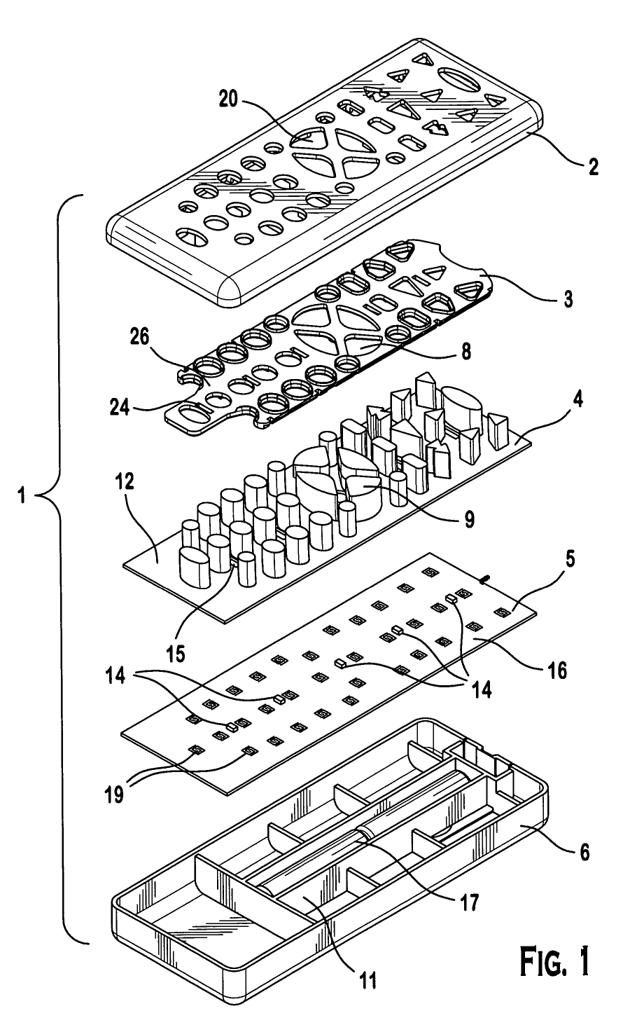

FIG. 1 shows an electronic device remote control 1. The remote control I includes a two-cover housing consisting of a top cover 2 and a bottom cover 6, a light pipe 3, a keypad 4, and a circuit board 5. As shown in FIG. 1, the circuit board 5 has a top surface 16 provided with a plurality of conductive contacts 19, such as carbon contacts, connected by a plurality of circuit traces (not shown) coupled to a power supply 17. Arranged along a longitudinal axis of the top surface 16 of the circuit board 5 is a plurality of surface mounted light emitting diodes (LED) 14. Although in the embodiment shown, the LEDs 14 are arranged along the longitudinal axis, the LEDs may be arranged in any of a variety of ways to achieve a desired light distribution. The LEDs 14 are connected to the circuit traces (not shown) and are electrically configured to emit light when pressure is applied to the keypad 4.

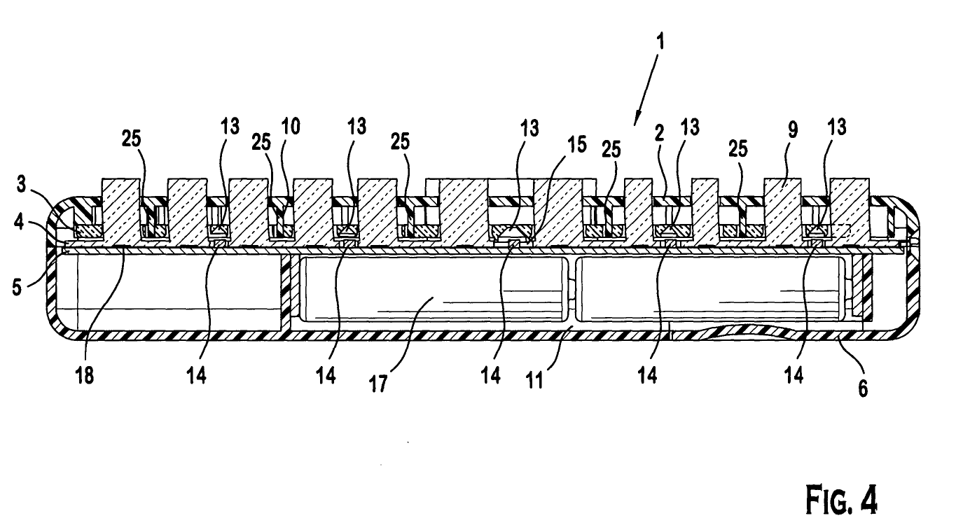

As shown in FIG. 1, the keypad 4 has a base 12 provided with a plurality of buttons 9 that extend therefrom. As best shown in FIG. 4, a contact 18 is provided on a bottom surface of each of the buttons 9. The contacts 18 correspond to the conductive contacts 19 of the circuit board 5 such that when the buttons 9 are pushed toward the circuit board 5, the contacts 18 contact the conductive contacts 19 to make an electrical connection. Located along the base 12 and adjacent to the buttons 9 are a plurality of LED receiving slots 15. The LED receiving slots 15 correspond to the position of the LEDs 14 arranged on the top surface 16 of the circuit board 5. The keypad 4 is formed from a translucent or pliable light transmitting material, such as a translucent rubber material.

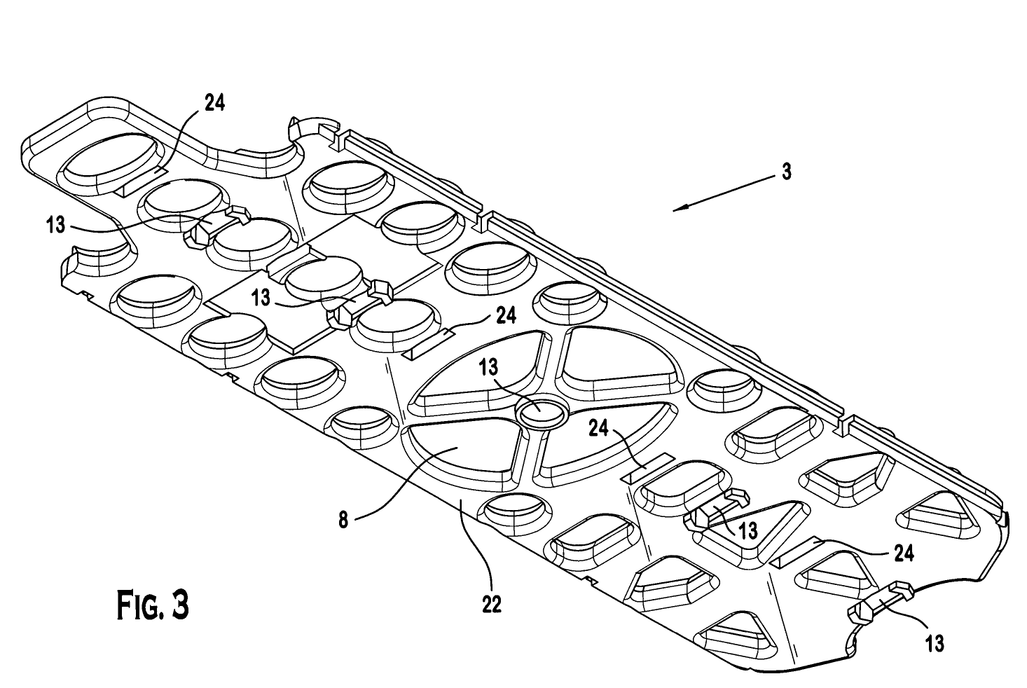

As best shown in FIG. 3, the light pipe 3 is made of a substantially translucent plastic material and has a thickness less than a height of the buttons 9. A plurality of openings 8 that correspond to the buttons 9 extend from a top surface 26 of the light pipe 3 through to a bottom surface 22 of the light pipe 3 such that the buttons 9 may be received therein. Adjacent to the openings 8 are a plurality of elongated cut-outs 24. The cut-outs 24 extend from a top surface 26 of the light pipe 3 through to a bottom surface 22 of the light pipe 3 such that projections 25 on the top cover 2 may be received therein, described in more detail below. Along the bottom surface 22 of the light pipe 3 and adjacent to the openings 8 and cut-outs 24 are a plurality of light dispersing slots 13. The light dispersing slots 13 correspond to the LED receiving slots 15 on the keypad 4 and have angled raised portions for aiding in distribution of the light. In the embodiment shown, the light pipe 3 is substantially the same size as the keypad 4, however, the light pipe 3 may be formed in any of a variety of shapes and sizes to achieve a desired light distribution. The light dispersing slots 13 of the light pipe 3 may also be formed and arranged to achieve a desired light distribution.

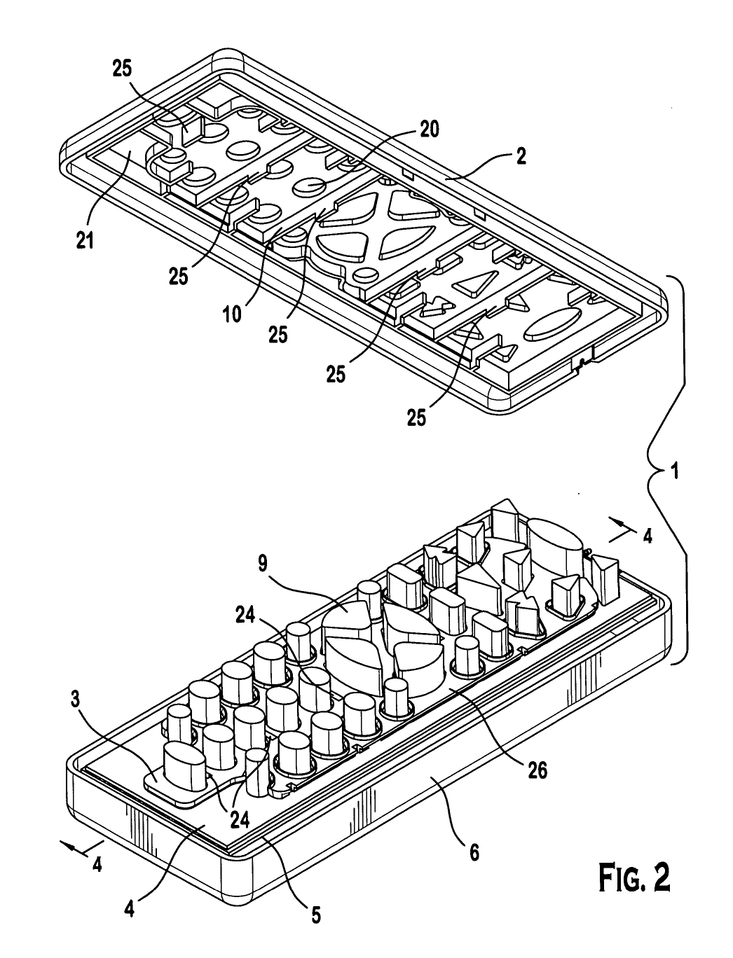

As shown in FIG. 1, the top cover 2 is formed of a plastic material and has a plurality of apertures 20 extending therethrough that correspond to the buttons 9 on the keypad 4. The apertures 20 are formed such that the buttons 9 may be received therein. As best shown in FIG. 2, adjacent to the apertures 20 and arranged on an inside surface 21 of the top cover 2 is a plurality of spaced apart dividers 10. The dividers 10 extend from the inside surface 21 of the top cover 6 toward the keypad 4. The dividers 10 are of a length such that the dividers 10 contact the top surface 26 of the light pipe 3 to assist in holding the light pipe 3 in position. A plurality of the dividers 10 has projections 25 that correspond with the cut-outs 24 of the light pipe 3. The projections 25 are received in the cut-outs 24 such that the projections 25 contact the base 12 of the keypad 4. The projections 25 serve to hold the keypad 4 in position in remote controls manufactured without the light pipe 3. The dividers 10 are arranged such that the dividers 10 extend adjacent to side surfaces of the buttons 9 when the buttons 9 are received in the apertures 20.

As shown in FIG. 1, the bottom cover 6 is formed of a plastic material and has a compartment 11 configured to receive a power supply 17, such as a plurality of batteries, that is electrically connected to the traces (not shown) of the circuit board 5. The bottom cover 6 and the top cover 2 are formed to mutually interlock with each other.

The assembly of the electronic device remote control 1 with the light pipe 3 provided for back lighting will now be described. As shown in FIGS. 1 and 4, the circuit board 5 is electrically connected to the power supply 17 by positioning the circuit board 5 in the bottom cover 6 such that the conductive contacts 19 and LEDs 14 are positioned away from the bottom cover 6. The keypad 4 is positioned adjacent to the top surface 16 of the circuit board 5 such that the contacts 18 correspond to the conductive contacts 19, and the LEDs 14 are received in the LED receiving slots 15. The light pipe 3 is positioned adjacent to the top surface 12 of the keypad 4 by inserting the buttons 9 through the openings 8 such that the light dispersing slits 13 correspond with the LEDs 14. The buttons 9 of the keypad 4 are then received in the apertures 20 of the top cover 2 such that the buttons 9 project through the apertures 20, and the dividers 10 are positioned adjacent to the side surfaces of the buttons 9. The dividers 10 contact the top surface 26 of the light pipe 3 and the projections 25 are received in the cut-outs 24 such that the projections 25 contact the base 12 of the keypad 4. The top cover 2 and the bottom cover 6 are interlocked to form a completed electronic device remote control 1. In operation, the LEDs 14 are illuminated by the power supply 17, and the light from the LEDs 14 is distributed through the light pipe 3 by the light dispersing slits 13. The light thereby illuminates the buttons 9 of the keypad 4.

The assembly of the electronic device remote control 1 without the light pipe 3 provided for back lighting will now be described. As shown in FIGS. 1 and 4, the circuit board 5 is electrically connected to the power supply 17 by positioning the circuit board 5 in the bottom cover 6 such that the conductive contacts 19 are positioned away from the bottom cover 6. The keypad 4 is positioned adjacent to the top surface 16 of the circuit board 5 such that the contacts 18 correspond to the conductive contacts 19. The buttons 9 of the keypad 4 are received in the apertures 20 of the top cover 2 such that the buttons 9 project through the apertures 20. The dividers 10 are thereby positioned adjacent to the side surfaces of the buttons 9, and the projections 25 contact the base 12 of the keypad 4. The top cover 2 and the bottom cover 6 are interlocked to form a completed electronic device remote control 1.

Because the light pipe 3 of the electronic device remote control 1 described herein is positioned between the top cover 2 and the keypad 3, the light pipe 3 may be used to convert existing remote controls without back lighting to remote controls with back lighting without re-designing the remote control to compensate for the thickness of the light pipe 3. In addition, remote controls may be produced with and without back lighting without the need for different tooling. Separate tooling is not required because the remote controls without back lighting may be manufactured in the same way as the remote controls with back lighting with the only difference being the absence of the light pipe 3. The positioning of the light pipe 3 between the top cover 2 and the keypad 3 also enables the size and shape of the light pipe 3 to easily be altered to modulate light distribution.

The foregoing illustrates some of the possibilities for practicing the invention. Many other embodiments are possible within the scope and spirit of the invention. It is, therefore, intended that the foregoing description be regarded as illustrative rather than limiting, and that the scope of the invention is given by the appended claims together with their full range of equivalents.

1. An electronic device remote control with back lighting, comprising:
a housing including a top cover having a plurality of apertures and a bottom cover;
a circuit board having a light emitting diode;
a keypad having a base with a plurality of buttons extending through the apertures of the top cover; and
a light pipe positioned on a top surface of the keypad between the top cover of the housing and the keypad so that light is dispersed through the light pipe to the buttons.

2. The remote control of claim 1, wherein the base of the keypad has at least one slot corresponding to the light emitting diode.

3. The remote control of claim 1, wherein the light emitting diode is surface mounted to the circuit board.

4. The remote control of claim 1, wherein the light pipe includes openings corresponding to the buttons of the keypad for receiving the buttons therein.

5. The remote control of claim 1, wherein the top cover includes dividers extending from an inside surface of the top cover toward the base of the keypad that are arranged to receive the buttons therebetween.

6. The remote control of claim 5, wherein the dividers contact the light pipe.

7. The remote control of claim 6, wherein the dividers contact the base of the keypad through cut-outs in the light pipe.

8. The remote control of claim 5, wherein the dividers contact the base of the keypad.

9. The remote control of claim 1, wherein the light pipe has at least one light dispersing slot corresponding to the at least one surface mounted light emitting diode.

10. The remote control of claim 1, wherein the buttons include contacts that correspond to conductive contacts on the circuit board such that when the buttons are pushed toward the circuit board, the contacts contact the conductive contacts to make an electrical connection.

11. The remote control of claim 1, wherein the light pipe is the same size as the keypad.

12. An electronic device remote control with back lighting, comprising:
a housing;
a circuit board having at least one surface mounted light emitting diode;
a keypad having a base positioned on a top surface of the circuit board, the base having a plurality of buttons extending away from the circuit board and at least one slot corresponding to the at least one surface mounted light emitting diode; and
a light pipe having openings corresponding to the buttons of the keypad, the light pipe being positioned on the keypad such that buttons extend through the openings therein so that light is dispersed through the light pipe to the buttons.

13. The remote control of claim 12, wherein the housing includes a top cover having a plurality of apertures corresponding to the buttons and dividers extending from an inside surface of the top cover toward the base of the keypad that are arranged to receive the buttons therebetween.

14. The remote control of claim 13, wherein the dividers contact the light pipe.

15. The remote control of claim 14, wherein the dividers contact the base of the keypad through cut-outs in the light pipe.

16. The remote control of claim 13, wherein the dividers contact the keypad.

17. The remote control of claim 12, wherein the light emitting diodes are arranged along a longitudinal axis of the circuit board.

18. The remote control of claim 12, wherein the light pipe is the same size as the keypad.

19. The remote control of claim 12, wherein the buttons include contacts that correspond to conductive contacts on the circuit board such that when the buttons are pushed toward the circuit board, the contacts contact the conductive contacts to make an electrical connection.

20. The remote control of claim 12, wherein the light pipe has at least one light dispersing slot corresponding to the at least one surface mounted light emitting diode.
